(19) United States
(12) Patent Application Publication
(10) Pub. No.: US 2005/0242970 A1
(43) Pub. Date: Nov. 3, 2005

(54) System and method for wireless control of remote electronic systems including functionality based on location

(75) Inventors: David A. Blaker, Holland, MI (US); John D. Spencer, Allendale, MI (US); Todd R. Witkowski, Zeeland, MI (US)

Correspondence Address: FOLEY & LARDNER, 777 EAST WISCONSIN AVENUE, SUITE 3800, MILWAUKEE, WI, 53202-5308, US

(73) Assignee: Johnson Control Technology Company, Holland, MI (US)

(21) Appl. No.: 10/530,588

(22) PCT Filed: Oct. 8, 2003
(86) PCT No.: PCT/US03/31977

§ 371 Date: Apr. 7, 2005

Related U.S. Application Data
(60) Provisional application No. 60/416,829, filed on Oct. 8, 2002.

(51) Int. Cl. H04Q 9/00; G08C 19/22

(52) U.S. Cl. 340/870.07

(57) ABSTRACT

A wireless control system for customizing a wireless control signal for a remote electronic system based on the location of the wireless control system includes a transmitter circuit, an interface circuit, and a control circuit. The transmitter circuit is configured to transmit a wireless control signal having control data which will control the remote electronic system. The interface circuit is configured to receive navigation data from a navigation data source. The control circuit is configured to receive a transmit command, to receive navigation data, to determine a current location based on the navigation data, and to command the transmitter circuit to transmit a wireless control signal associated with the current location.

### BACKGROUND

In the field of wireless control of remote electronic systems, technological advances have been developed to improve convenience, security, and functionality for the user. One example is a trainable transceiver for use with various remote electronic systems, such as security gates, garage door openers, lights, and security systems. A user trains the trainable transceiver by, for example, transmitting a signal from a remote controller in the vicinity of the trainable transceiver. The trainable transceiver learns the carrier frequency and data code of the signal and stores this code for later retransmission. In this manner, the trainable transceiver can be conveniently mounted within a vehicle interior element (e.g., visor, instrument panel, overhead console, etc.) and can be configured to operate one or more remote electronic systems.

Further advances are needed in the field of wireless control of remote electronic systems, particularly in the case of using automotive electronics to control remote electronic systems. As automotive manufacturers are adding increased electronic systems to the vehicle to improve convenience, comfort, and productivity, simplifying the interface and control of these electronic systems is also becoming increasingly important. In addition, as automotive manufacturers are adding increased electronic systems to the vehicle, providing greater control over more systems is also becoming increasingly important.

Navigation systems, such as the global positioning system, vehicle compass, distance sensors, and other navigation systems, are being added to vehicles to provide navigation information to the vehicle occupants. On-board navigation systems also present opportunities to improve existing electronic systems to take advantage of vehicle location data which was not previously available.

What is needed is an improved wireless control system and method for wireless control of a remote electronic system from a vehicle, wherein the location of the vehicle is used to improve the convenience by customizing the functionality of the wireless control system. Further, what is needed is a system and method of customizing inputs for a wireless control system on a vehicle for wireless control of a remote electronic system based on the location of the vehicle. Further still, what is needed is a transmitter for wirelessly controlling a plurality of remote electronic systems through a single input.

The teachings hereinbelow extend to those embodiments which fall within the scope of the appended claims, regardless of whether they accomplish one or more of the above-mentioned needs.

### SUMMARY

According to an exemplary embodiment, a wireless control system for customizing a wireless control signal for a remote electronic system based on the location of the wireless control system includes a transmitter circuit, an interface circuit, and a control circuit. The transmitter circuit is configured to transmit a wireless control signal having control data which will control the remote electronic system. The interface circuit is configured to receive navigation data from a navigation data source. The control circuit is configured to receive a transmit command, to receive navigation data, to determine a current location based on the navigation data, and to command the transmitter circuit to transmit a wireless control signal associated with the current location.

According to another exemplary embodiment, a method of training a wireless control system on a vehicle for wireless control of a remote electronic system based on the location of the vehicle includes receiving a request to begin training from a user. The method further includes receiving a current location for the vehicle. The method further includes providing control data for a signal to be sent wirelessly for a remote electronic system. The method further includes associating the current location for the vehicle with the control data for the remote electronic system.

According to yet another exemplary embodiment, a method of transmitting a wireless control signal for controlling a remote electronic system based on the location of a vehicle includes receiving a current location for a vehicle. The method further includes comparing the current location of the vehicle with a plurality of stored locations, each location associated with a wireless control signal. The method further includes determining the wireless control signal associated with the stored location closed to the current location and transmitting the wireless control signal associated with the stored location closest to the current location.

According to still another exemplary embodiment, a transmitter for wirelessly controlling a plurality of remote electronic systems at one of a plurality of locations includes a memory, a transmitter circuit, and a control circuit. The memory is configured to store a plurality of control data messages and a plurality of locations, each control data message configured to control a different remote electronic system. The memory is configured to associate each location with a plurality of control data messages. The control circuit is configured to command the transmitter circuit to transmit a plurality of wireless control signals associated with a location in response to a single event, each wireless control signal containing a different control data message.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a perspective view of a vehicle having a wireless control system, according to an exemplary embodiment;

FIG. 2 is a block diagram of a wireless control system and a plurality of remote electronic systems, according to an exemplary embodiment;

FIG. 3 is a schematic diagram of a visor having a wireless control system mounted thereto, according to an exemplary embodiment;

FIG. 4 is a flowchart of a method of training the wireless control system of FIG. 2, according to an exemplary embodiment;

FIG. 5 is a chart of a set of data pairs stored in memory, each data pair including a location and a corresponding control signal, according to an exemplary embodiment;

FIG. 6 is a block diagram of a transmitter for wirelessly controlling a plurality of remote electronic systems at a plurality of locations, according to an exemplary embodiment; and

FIG. 7 is a flowchart of a method of wireless control of a remote electronic system based on location, according to an exemplary embodiment.

### DETAILED DESCRIPTION OF EXEMPLARY EMBODIMENTS

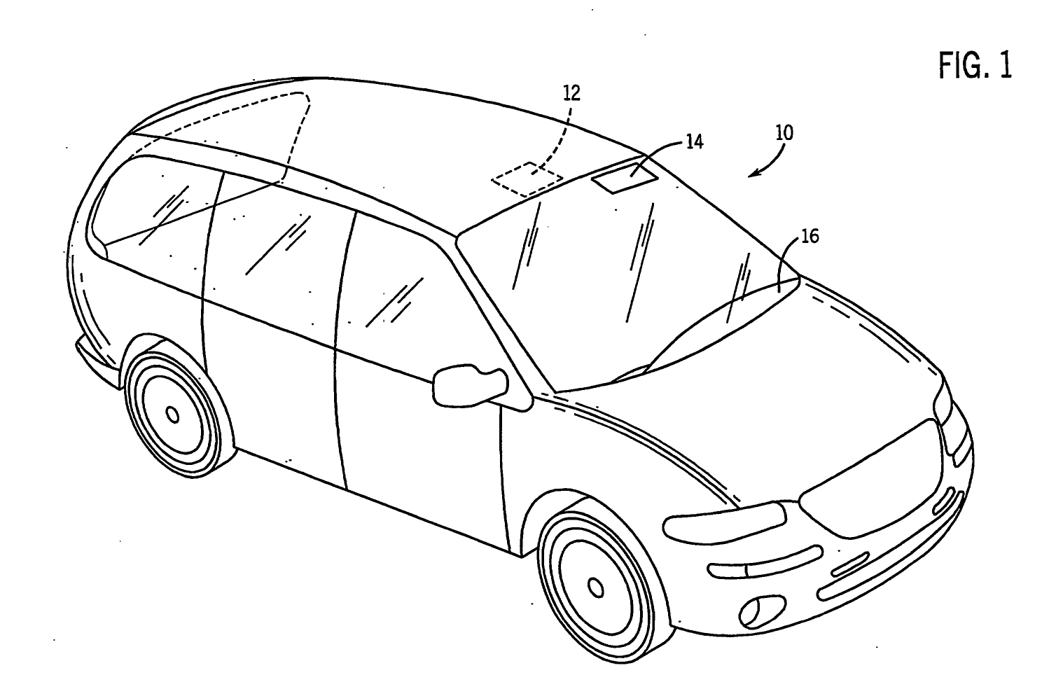

Referring first to FIG. 1, a vehicle 10, which may be an automobile, truck, sport utility vehicle (SUV), mini-van, or other vehicle, includes a wireless control system 12. Wireless control system 12, the exemplary embodiments of which will be described hereinbelow, is illustrated mounted to an overhead console of vehicle 10. Alternatively, one or more of the elements of wireless control system 12 may be mounted to other vehicle interior elements, such as, a visor 14, an overhead console, or instrument panel 16. Alternatively, wireless control system 12 could be mounted to a key chain, keyfob or other handheld device.

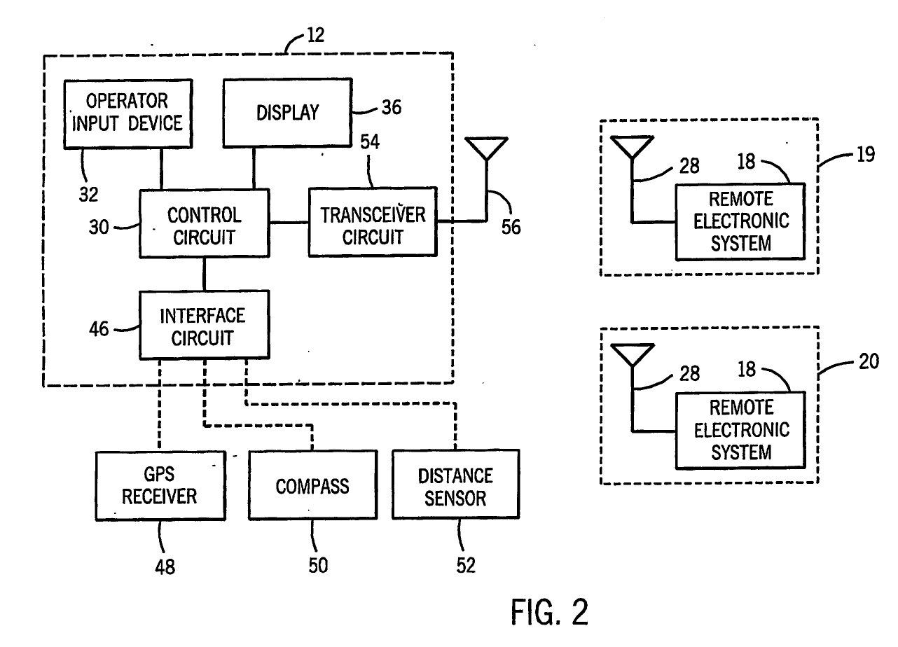

Referring now to FIG. 2, wireless control system 12 is illustrated along with a first remote electronic system 18 at a first location 19 and a second remote electronic system 18 at a second location 20. Remote electronic system 18 may be any of a plurality of remote electronic systems, such as, a garage door opener, a security gate control system, security lights, home lighting fixtures or appliances, a home security system, etc. For example, the remote electronic systems may be garage door openers, such as the Whisper Drive garage door opener, manufactured by the Chamberlain Group, Inc., Elmhurst, Illinois. The remote electronic systems may also be lighting control systems using the X10 communication standard. Remote electronic system 18 includes an antenna 28 for receiving wireless signals including control data which will control remote electronic system 18. The wireless signals are preferably in the ultra-high frequency (UHF) band of the radio frequency spectrum, but may alternatively be infrared signals or other wireless signals.

First location 19 and second location 20 may be any location including a remote electronic system 18. For example, first location 19 may be the residence of a user including a garage door opener and a security system, and second location 20 may be the office of a user including a parking structure gate configured to be operated by a wireless control signal.

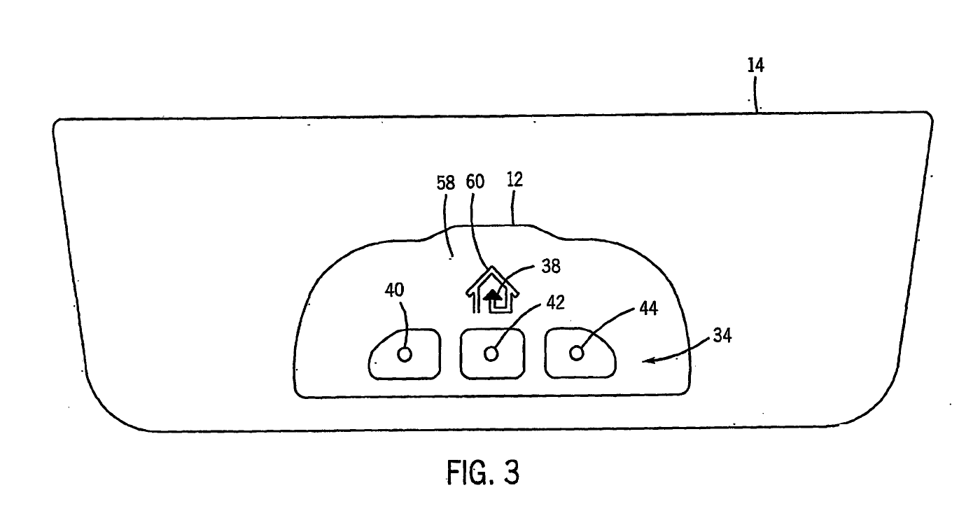

Wireless control system 12 includes a control circuit 30 configured to control the various portions of system 12, to store data in memory, to operate preprogrammed functionality, etc. Control circuit 30 may include various types of control circuitry, digital and/or analog, and may include a microprocessor, microcontroller, application-specific integrated circuit (ASIC), or other circuitry configured to perform various input/output, control, analysis, and other functions to be described herein. Control circuit 30 is coupled to an operator input device 32 which includes one or more push button switches 34 (see FIG. 3), but may alternatively include other user input devices, such as, switches, knobs, dials, etc.; or more advanced input devices, such as biometric devices including fingerprint or eye scan devices or even a voice-actuated input control circuit configured to receive voice signals from a vehicle occupant and to provide such signals to control circuit 30 for control of system 12.

Control circuit 30 is further coupled to a display 36 which includes a light-emitting diode (LED), such as, display element 38. Display 36 may alternatively include other display elements, such as a liquid crystal display (LCD), a vacuum florescent display (VFD), or other display elements.

Wireless control system 12 further includes an interface circuit configured to receive navigation data from one or more navigation data sources, such as a GPS receiver 48, a vehicle compass 50, a distance sensor 52, and/or other sources of navigation data, such as gyroscopes, etc. Interface circuit 46 is an electrical connector in this exemplary embodiment having pins or other conductors for receiving power and ground, and one or more navigation data signals from a vehicle power source and one or more navigation data sources, respectively, and for providing these electrical signals to control circuit 30. GPS receiver 48 is configured to receive positioning signals from GPS satellites, to generate location signals (e.g., latitude/longitude/altitude) representative of the location of wireless control system 12, and to provide these location signals to control circuit 30 via interface circuit 46. Compass 50 includes compass sensors and processing circuitry configured to receive signals from the sensors representative of the Earth's magnetic field and to provide a vehicle heading to control circuit 30. Compass 50 may use any magnetic sensing technology, such as magneto-resistive, magneto-inductive, or flux gate sensors. The vehicle heading may be provided as an octant heading (N, NE, E, SE, etc.) or in degrees relative to North, or in some other format. Distance sensor 52 may include an encoder-type sensor to measure velocity and/or position or may be another distance sensor type. In this embodiment, distance sensor 52 is a magnetic sensor coupled to the transmission and configured to detect the velocity of the vehicle. A vehicle bus interface receives the detected signals and calculates the distance traveled based on a clock pulse on the vehicle bus. Other distance and/or velocity sensor types are contemplated, such as, using GPS positioning data.

Wireless control system 12 further includes a transceiver circuit 54 including transmit and/or receive circuitry configured to communicate via antenna 56 with a remote electronic system 18. Transceiver circuit 54 is configured to transmit wireless control signals having control data which will control a remote electronic system 18. Transceiver circuit 54 is configured, under control from control circuit 30, to generate a carrier frequency at any of a number of frequencies in the ultra-high frequency range, preferably between 260 and 470 megaHertz (MHz), wherein the control data modulated on to the carrier frequency signal may be frequency shift key (FSK) or amplitude shift key (ASK) modulated, or may use another modulation technique. The control data on the wireless control signal may be a fixed code or a rolling code or other cryptographically encoded control code suitable for use with remote electronic system 18.

Referring now to FIG. 3, an exemplary wireless control system 10 is illustrated coupled to a vehicle interior element, namely a visor 14. Visor 14 is of conventional construction, employing a substantially flat, durable interior surrounded by a cushioned or leather exterior. Wireless control system 12 is mounted to visor 14 by fasteners, such as, snap fasteners, barbs, screws, bosses, etc. and includes a molded plastic body 58 having three push button switches disposed therein. Each of the switches includes a respective back-lit icon 40, 42, 44. Body 58 further includes a logo 60 inscribed in or printed on body 58 and having a display element 30 disposed therewith. During training and during operation, display element 38 is selectively lit by control circuit 30 (FIG. 2) to communicate certain information to the user, such as, whether a training process was successful, whether the control system 12 is transmitting a wireless control signal, etc. The embodiment shown in FIG. 3 is merely exemplary, and alternative embodiments may take a variety of shapes and sizes, and have a variety of different elements.

In operation, wireless control system 12 is configured for wireless control of remote electronic system 18 at first location 19 and/or remote electronic system 18 at second location 20 dependent on the location of wireless control system 12. Control circuit 30 is configured to receive navigation data from a navigation data source to determine a proximity between system 12 and first location 19 and between system 12 and second location 20, and to command transceiver circuit 54 to transmit a wireless control signal based on the proximity between system 12 and first location 19 as compared to the proximity between system 12 and second location 20. For example, if system 12 is closer in proximity to first location 19, a wireless control signal associated with system 18 at first location 19 will be transmitted. In contrast, if system 12 is closer in proximity to second location 20, a wireless control signal associated with system 18, at second location 20 will be transmitted. According to an embodiment, the user of system 12 can train system 12 to learn locations 19 and 20. For example, when system 12 is located at first location 19, the user can actuate operator input device 32 to cause control circuit to receive and store the location from data provided by one or more of GPS receiver 48, compass 50, and/or distance sensor 52. According to an alternative embodiment, a user of system 12 can manually enter a longitude and latitude to define first location 19 or second location 20. System 12 will thereafter transmit the wireless control signal associated with remote electronic system 18 at first location 19 in response to a single event

According to an alternative embodiment, the current location can be determined by using the vehicle compass and a speed signal to determine the current location. The system can monitor the path the vehicle is taking and compare it to stored paths (e.g. the vehicle was just traveling 40 mph for 2 miles, then turned right, traveled 0.5 miles at 20 mph, then turned left) Where the current path matches a stored path indicating a location proximate to remote electronic system 18, the wireless control signal for remote electronic system 18 will be transmitted.

According to an alternative embodiment, system 12 can be configured to transmit a wireless control signal associated with system 18 at first location 19 only when system 12 is within a known transmission range to the location. Where system 12 is not within range of any known remote electronic system 18, system 12 can be configured to provide some other function in response to the single event such as displaying a message indicating that system 12 is out of range.

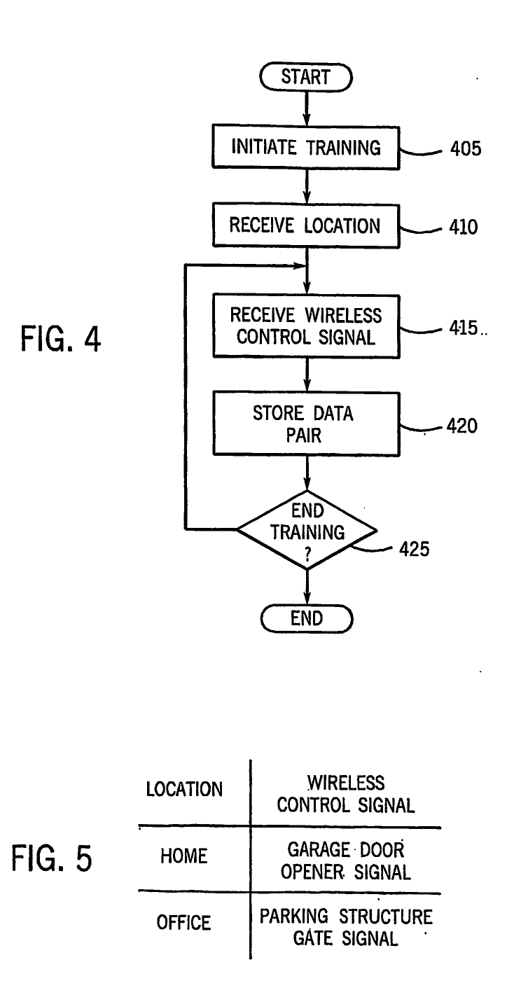

Referring now to FIG. 4, several training steps can be performed by the user. System 12 is trained to learn the location of both remote electronic system 18 at first location 19 and remote electronic system 18 at second location 20.

In this exemplary embodiment, system 12 learns according to a method for training a remote electronic system 18 at first location 19, in which data from GPS receiver 48 is available. In a first step 405, the user actuates one of switches 34 to change the mode of wireless control system 12 to a training mode. For example, the user may hold down one, two, or more of switches 34 for a predetermined time period (e.g., 10 seconds, 20 seconds, etc.) to place control circuit 30 in a training mode, or the user may actuate a separate input device (not shown in FIG. 3) coupled to control circuit 30 (FIG. 2) to place system 12 in the training mode.

In a step 410, with system 12, and more particularly the antenna of GPS receiver 48, positioned at first location 19, the user actuates one of the switches 34 to command control circuit 30 to take a location reading from GPS receiver 48 and to store this location information in memory, preferably in non-volatile memory, in order to train system 12 to learn the location of first remote electronic system 18.

In a step 415, the user indicates the wireless control signal to be associated with the current location. This step can be performed by selecting a previously stored wireless control signal or by inputting a new wireless control signal. A new wireless control signal can be input by actuating an original transmitter for remote electronic system 18 in proximity to system 12 for capture by system 12 as is well known in the art. While actuating the original transmitter, the user actuates one of the switches 34 to command control circuit 30 to capture the wireless control signal.

The information received in steps 410 and 415 can be stored as an associated data pair in a step 420. FIG. 5 illustrates a set of stored locations and associated wireless control signals, stored as a plurality of data pairs. Each data pair includes a location and a wireless control signal. For example, in the exemplary data pairs shown, a home location (represented by a longitude and latitude) and a wireless control signal for a garage door opener are stored as a first pair, while an office location (also represented by a longitude and latitude) and a wireless control signal for a parking structure opener are stored as a second pair. Alternatively, in a system wherein a plurality of wireless control signals can be associated with a single location, described further with reference to FIG. 5, a table can include a single location associated with a plurality of wireless control signals.

Following storage of the data pair, a determination can be made in a step 425 whether additional training is desired. If additional training is desired, the system can return to step 415 to receive an additional wireless control signal for association with the location received in step 410. If no additional training is desired, training mode can be exited.

According to an alternative embodiment, the training process may be automated such that system 12 is configured to capture a wireless control signal whenever an original transmitter sending a wireless control signal is actuated within close proximity to system 12. Upon determining that a new wireless control signal has been detected, system 12 determines the current location and stores the current location along with the detected wireless control signal in a new data pair. For example, a person approaching a parking garage for the first time may actuate a parking garage transmitter to open a gate to the parking garage. Upon detecting the parking garage wireless control signal from the parking garage transmitter and recognizing it as a new wireless control signal, system 12 stores the parking garage wireless control signal along with the current location in proximity to the parking garage in a new data pair. Subsequently, system 12 may be configured to transmit the parking garage wireless control signal when actuated in proximity to the parking garage. System 12 may also include additional features to facilitate automated training such as a prompt to the user whether a detected wireless control signal should be stored, security features to prevent accidental storage, etc.

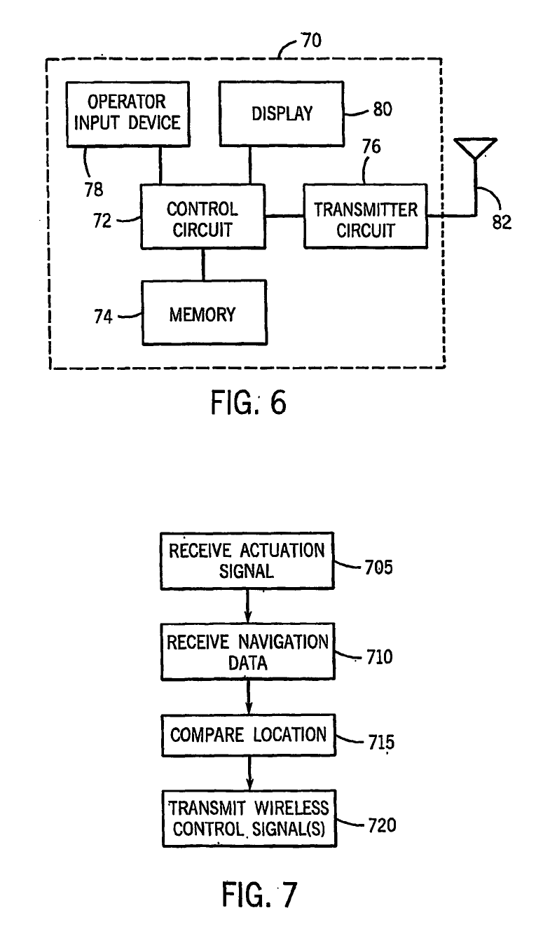

Referring now to FIG. 6, a transmitter or transceiver 70 for wirelessly controlling a plurality of remote electronic systems at a single location is illustrated, wherein the transmitter is configured to transmit a plurality of wireless control signals in response to a single event. Transmitter 70 includes a control circuit 72 similar to control circuit 30. Transmitter 70 further includes a memory 74, which may be a volatile or non-volatile memory, and may include read only memory (ROM), random access memory (RAM), flash memory, or other memory types. Transmitter 70 further includes a transmitter circuit 76 which may alternatively include receive circuitry, wherein transmitter circuit 76 is configured to transmit wireless control signals to one or more of first remote electronic systems 18 (FIG. 2). Transmitter 70 may be a hand-held transmitter, or may be mounted to a vehicle interior element. Transmitter 70 includes a memory 74 configured to store a plurality of control data, each control data configured to control a different remote electronic system. Transmitter 70 may further include an operator input device 78 and a display 80, which may have a similar configuration to operator input device 32 and display 36 in the embodiment of FIG. 2. The following feature of transmitting multiple wireless signals may be provided in the simplified transmitter of FIG. 6 or may alternatively be provided in system 12 in any of its various embodiments.

In operation, control circuit 72 is configured to command transmitter circuit 76 to transmit a plurality of wireless control signals over antenna 82 in response to a single event. Each wireless control signal contains a different control data message, each control data message being retrieved from memory 74. The wireless control signals may be radio frequency, infrared, or other wireless signals. The single event may be the operator actuation of operator input device 78 by a vehicle occupant. Alternatively, or in addition, control circuit 72 may be configured to receive navigation data and to determine a distance between the transmitter and first remote electronic system 18, in which case the single event can be the control circuit 72 determining that the transmitter 70 is within a predetermined distance of first remote electronic system 18.

Control circuit 72 is user-programmable such that the switch in operator input device 78 causes transmitter circuit 76 to send a first wireless control signal (e.g., to turn on security lights, open a security gate, etc.) and the control circuit 72 automatically sends a second wireless control signal different than the first wireless control signal (e.g., to lift a garage door) when control circuit 72 determines that transmitter 70 is within a predetermined distance of first remote electronic system 18. Further still, one switch within operator input device 78, may cause transmitter circuit 76 to send a first wireless control signal and a second switch within operator input 78 may cause transmitter 76 to send multiple control signals, wherein the multiple wireless control signals are transmitted simultaneously or in sequence.

In an exemplary embodiment wherein system 12 or transmitter 70 sends a plurality of different wireless control signals in response to actuation of one switch, one of the wireless control signals can be transmitted for a first predetermined time period (e.g., 1 to 2 seconds), then the second wireless control signals can be transmitted for a predetermined time period, (e.g., 1 to 2 seconds) and the cycle of transmissions can be repeated until the switch is released.

Referring now to FIG. 7, an exemplary method of transmitting a wireless control signal from a wireless control system on a vehicle for wireless control of a remote electronic system based on the location of the wireless control system will now be described. At a step 705, an actuation signal is received. The actuation signal can be received as the result of a user input, an automatic actuation based on a distance between a current location and remote electronic system 18, an automatic actuation based on timing information, or any other event.

In response to receipt of the actuation signal, navigation data indicative of the current location of system 12 is received in a step 710. The navigation data can be received by uploading from a continually updated location in memory containing the current location, through an interface circuit to an external navigation device, as the result of a user selection of the current location, or any other method.

In a step 715, the navigation information received in step 710 is compared to a listing of known locations stored in memory as described with reference to FIGS. 4 and 5. In step 715, according to an exemplary embodiment, the current location of system 12 is compared to the known locations to determine the known location that is most proximate to system 12. The determination can be made by comparing the longitude and latitude of the current location to the longitude and latitude of the known location.

After the most proximate known location is determined in step 715, the wireless control signal or plurality of wireless control signals associated with the most proximate known location can be retrieved and transmitted in a step 720. According to an alternative embodiment, a determination can be made prior to step 720 whether the known location is within transmission range of remote electronic system 18. The determination can be made by comparing a stored transmission range with the distance determined in step 715 of the distance between system 12 and the known location. If system 12 is within range of the known location, the wireless control signal is transmitted; if not, an out-of-range indicator can be provided to the user.

1. A wireless control system for customizing a wireless control signal for a remote electronic system based on the location of the wireless control system, comprising:
a transmitter circuit configured to transmit the wireless control signal having control data which will control the remote electronic system;
an interface circuit configured to receive navigation data from a navigation data source; and
a control circuit coupled to the transmitter circuit and the interface circuit configured to receive a transmit command, to receive navigation data, to determine a current location based on the navigation data, and to command the transmitter circuit to transmit a wireless control signal associated with the current location.

2. The wireless control system of claim 1, further comprising a vehicle interior element coupled to the transmitter circuit and the control circuit, wherein the wireless control system is configured for mounting in a vehicle interior.

3. The wireless control system of claim 2, wherein the vehicle interior element is an overhead console, a visor, or an instrument panel.

4. The wireless control system of claim 1, wherein the control circuit is operable in a training mode to record location data and wireless control signals in sets of data pairs, wherein each set of data pairs represents a location proximate to a remote electronic system associated with the wireless control signal stored in the data pair.

5. The wireless control system of claim 4, wherein the control circuit is configured to search a plurality of data pairs to compare a current location to the location proximate to the remote electronic system stored in each data pair, and the control circuit is configured to command the transmitter to transmit the wireless control signal from a data pair when a location proximate to the remote electronic system for that data pair is proximate to the current location.

6. The wireless control system of claim 1, further comprising a receiver circuit configured to receive a wireless signal, wherein the control circuit is configured to identify and store a data code on the wireless signal, wherein the wireless control signal transmitted by the transmitter circuit includes the stored data code.

7. The wireless control system of claim 6, wherein the control circuit is further configured to automatically associate a location with the stored data code and to store the location in a data pair with the stored data code.

8. A method of training a wireless control system on a vehicle for wireless control of a remote electronic system based on the location of the vehicle, comprising:
receiving a request to begin training from a user;
receiving a current location for the vehicle;
providing control data for a signal to be sent wirelessly for a remote electronic system; and
associating the current location for the vehicle with the wireless control signal for the remote electronic system.

9. The method of claim 8, wherein the request to begin training is received via a pushbutton.

10. The method of claim 8, further comprising receiving an indication from the user as to which of a plurality of wireless control signals is to be transmitted based on the location of the vehicle.

11. The method of claim 8, further comprising:
receiving a wireless signal having a data code; and
identifying and storing the data code on the wireless signal, whereby the wireless control system can wirelessly control the remote electronic system by transmitting the data code of the wireless signal.

12. A method of transmitting a wireless control signal for controlling a remote electronic system based on the location of a vehicle, comprising:
receiving a current location for the vehicle;
comparing the current location of the vehicle with a plurality of stored locations, each location associated with a wireless control signal;
determining the wireless control signal associated with the stored location closest to the current location; and
transmitting the wireless control signal associated with the stored location closest to the current location.

13. The method of claim 12, wherein transmitting the wireless control signal associated with the stored location closest to the current location includes transmitting the wireless signal only upon determining that the current location is within a predefined distance of the stored location.

14. The method of claim 12, wherein the control data is configured to control a garage door opener.

15. The method of claim 12, wherein the step of transmitting includes transmitting a plurality of wireless control signals having different control data which will control a plurality of remote electronic systems when the comparing the current location of the vehicle with a listing of stored locations indicates that the vehicle is near the remote electronic systems.

16. The method of claim 12, wherein the navigation data source is a vehicle compass.

17. A transmitter for wirelessly controlling a plurality of remote electronic systems at one of a plurality of locations, comprising:
a memory configured to store a plurality of control data messages and a plurality of locations, each control data message configured to control a different remote electronic system, the memory configured to associate each location with a plurality of control data messages;
a transmitter circuit; and
a control circuit configured to command the transmitter circuit to transmit a plurality of wireless control signals in response to a single event, each wireless control signal containing a different control data message.

18. The transmitter of claim 17, further comprising an operator input device, wherein the single event is the actuation of the operator input device by a vehicle occupant.

19. The transmitter of claim 17, wherein the control circuit is configured to receive navigation data and to determine a proximity between the transmitter and the remote electronic systems, wherein the single event is the control circuit determining that the transmitter is within a predetermined proximity of the remote electronic systems.

20. The transmitter of claim 19, further comprising an operator-actuatable switch coupled to the control circuit, wherein the control circuit is user-programmable such that the switch causes the transmitter to send a first wireless control signal having a first control data message and the control circuit automatically sends a second wireless control signal having a second control data message different than the first control data message when the control circuit determines that the transmitter is within a predetermined proximity of the remote electronic system.

21. The transmitter of claim 17, further comprising a vehicle interior element coupled to the transmitter circuit and the control circuit, wherein the transmitter is configured for mounting in a vehicle interior.

22. The transmitter of claim 21, wherein the vehicle interior element is an overhead console, a visor, or an instrument panel.

23. The transmitter of claim 17, wherein the control circuit is configured to be programmed by the user as to which of the wireless control signals are to be transmitted in response to the single event.

24. The transmitter of claim 17, further comprising a plurality of operator-actuatable switches coupled to the control circuit, wherein the control circuit is user-programmable such that a first of the switches causes the transmitter to send a first wireless control signal and a second of the switches causes the transmitter to send second and third wireless control signals simultaneously or in sequence.
